(19) United States
(12) Patent Application Publication
(10) Pub. No.: US 2026/0112540 A1
(43) Pub. Date: Apr. 23, 2026

(54) MULTILAYER CERAMIC CAPACITOR

(71) Applicant: SAMSUNG ELECTRO-MECHANICS CO., LTD., Suwon-si (KR)

(72) Inventors: Ban Seok Choi, Suwon-si (KR); Myunghyun Jo, Suwon-si (KR); Eunchae Park, Suwon-si (KR); Geumhee Yun, Suwon-si (KR)

(73) Assignee: SAMSUNG ELECTRO-MECHANICS CO., LTD., Suwon-si (KR)

(21) Appl. No.: 19/077,652

(22) Filed: Mar. 12, 2025

(30) Foreign Application Priority Data
Oct. 21, 2024 (KR) 10-2024-0143568

(51) Int. Cl. H01G 4/224; H01G 4/005; H01G 4/12; H01G 4/232; H01G 4/248; H01G 4/30

(52) U.S. Cl. CPC H01G 4/224; H01G 4/005; H01G 4/12; H01G 4/2325; H01G 4/248; H01G 4/30

(57) ABSTRACT

A multilayer ceramic capacitor may include a body including a first surface and a second surface opposing each other in a first direction, a third surface and a fourth surface opposing each other in a second direction intersecting the first direction, a fifth surface and a sixth surface opposing each other a third direction intersecting both of the first direction and the second direction, and including a plurality of dielectric layers and a plurality of internal electrodes stacked in the third direction, and an external electrode disposed outside the body, where the body may include a margin region where no internal electrode is disposed, the margin region being disposed on an outer circumference of the plurality of internal electrodes toward the third surface and an outer circumference of the plurality of internal electrodes toward the fourth surface, where a ratio of a width of the margin region to a width of the body, measured along the second direction, is greater than 8.5% and less than or equal to 9.5%, and where an average porosity of the margin region is greater than 0% and less than 1.1%.

### RELATED APPLICATIONS

This application claims priority to and the benefit of Korean Patent Application No. 10-2024-0143568 filed in the Korean Intellectual Property Office on Oct. 21, 2024, the entire contents of which is incorporated herein by reference.

### BACKGROUND

### 1. Field

The present disclosure relates to a multilayer ceramic capacitor.

### 2. Description of the Related Art

Electronic components using ceramic materials include capacitors, inductors, piezoelectric elements, varistors, or thermistors. Among the ceramic electronic components, multilayer ceramic capacitors (MLCCs) may be used in various electronic devices due to its advantages of being small, having high capacity, and being easy to mount.

A multilayer ceramic capacitor may include a body that includes a plurality of dielectric layers and a plurality of internal electrodes, and an external electrode disposed outside the body and connected to the internal electrode. If moisture or hydrogen infiltrates into a margin region of the body, the moisture resistance reliability of the multilayer ceramic capacitor may deteriorate.

### SUMMARY

The present disclosure attempts to provide a multilayer ceramic capacitor capable of preventing deterioration of moisture resistance reliability.

A multilayer ceramic capacitor may include a body including a first surface and a second surface opposing each other in a first direction, a third surface and a fourth surface opposing each other in a second direction intersecting the first direction, a fifth surface and a sixth surface opposing each other a third direction intersecting both of the first direction and the second direction, and including a plurality of dielectric layers and a plurality of internal electrodes stacked in the third direction, and an external electrode disposed outside the body, where the body may include a margin region where no internal electrode is disposed, the margin region being disposed on an outer circumference of the plurality of internal electrodes toward the third surface and an outer circumference of the plurality of internal electrodes toward the fourth surface, where a ratio of a width of the margin region to a width of the body, measured along the second direction, is greater than 8.5% and less than or equal to 9.5%, and where an average porosity of the margin region is greater than 0% and less than 1.1%.

The margin region may include the same dielectric layer as the dielectric layer in the remaining regions of the body.

The plurality of internal electrodes may include a plurality of first internal electrodes and a plurality of second internal electrodes disposed staggered from each other in the first direction.

The external electrode may include a first external electrode disposed on the first surface and connected to the plurality of first internal electrodes, and a second external electrode disposed on the second surface and connected to the plurality of second internal electrodes.

The multilayer ceramic capacitor may further include a plating layer that covers the external electrode.

The plating layer may include a first layer covering the external electrode, a second layer covering the first layer, and a third layer covering the second layer.

The first layer may include nickel (Ni), the second layer may include copper (Cu), and the third layer may include tin (Sn).

According to a multilayer ceramic capacitor according to some embodiments of the present disclosure, deterioration of moisture resistance reliability may be prevented by preventing infiltration of moisture or hydrogen by adjusting the width and porosity of the margin region of the body.

### BRIEF DESCRIPTION OF THE DRAWINGS

FIG. 1 is a perspective view schematically showing a multilayer ceramic capacitor according to an embodiment.

FIG. 2 is an exploded perspective view schematically showing a stacking structure of internal electrodes of the multilayer ceramic capacitor of FIG. 1.

FIG. 3 is a top plan view schematically showing a first internal electrode of the multilayer ceramic capacitor of FIG. 1.

FIG. 4 is a top plan view schematically showing a second internal electrode of the multilayer ceramic capacitor of FIG. 1.

FIG. 5 is a cross-sectional view taken along line I-I′ of FIG. 1.

FIG. 6 is a cross-sectional view taken along line II-II′ of FIG. 1.

### DETAILED DESCRIPTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some components are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include,” “comprise,” “have,” or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

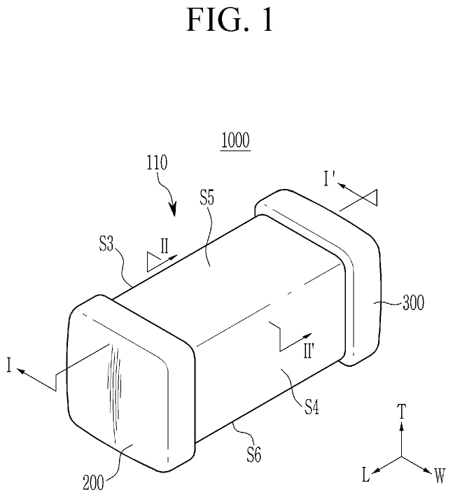

FIG. 1 is a perspective view schematically showing a multilayer ceramic capacitor according to an embodiment.

Referring to FIG. 1, a multilayer ceramic capacitor 1000 according to the present embodiment may include a body 110, a first external electrode 200, and a second external electrode 300.

First, directions are defined to clearly describe the present embodiment. An L-axis, a W-axis, and a T-axis shown in the drawings represent a length direction, a width direction and a thickness direction of the multilayer ceramic capacitor 1000, respectively.

The thickness direction (T-axis direction) may be a direction perpendicular to wide surfaces (major surface) of sheet-shaped components. For example, the thickness direction (T-axis direction) may be used as the same concept as a direction in which dielectric layers 140 are stacked.

The length direction (L-axis direction) is a direction parallel to wide surfaces (major surfaces) of sheet-shaped components, and may be a direction that intersects (or is orthogonal to) the thickness direction (T-axis direction). For example, the length direction (L-axis direction) may be a direction in which the first external electrode 200 and the second external electrode 300 oppose each other.

The width direction (W-axis direction) is a direction parallel to wide surfaces (major surfaces) of sheet-shaped components, and may be a direction that intersects (or is orthogonal to) both of the thickness direction (T-axis direction) and the length direction (L-axis direction).

The body 110 may have a roughly hexahedral shape, but the present embodiment is not limited thereto. Due to shrinkage during sintering, the body 110 may not have a perfect hexahedral shape, but may have a substantially hexahedral shape. For example, the body 110 has a substantially rectangular hexahedral shape, but a portion corresponding to an edge or vertex may have a rounded shape.

In the present embodiment, for convenience of description, surfaces opposing each other in the length direction (L-axis direction) of the body 110 are defined as a first surface S1 and a second surface S2, surfaces opposing each other in the width direction (W-axis direction) of the body 110 and connecting the first surface S1 and the second surface S2 may be defined as a third surface S3 and a fourth surface S4, and surfaces opposing each other in the thickness direction (T-axis direction) of the body 110 and connecting the first surface S1 and the second surface S2 may be defined as a fifth surface S5 and a sixth surface S6.

Therefore, the first direction, in which the first surface S1 and the second surface S2 oppose each other, may be the length direction (L-axis direction), and a second direction and a third direction perpendicular to the first direction and perpendicular to each other may be the thickness direction (T-axis direction) and the width direction (W-axis direction) or the width direction (W-axis direction) and the thickness direction (T-axis direction), respectively.

A length of the body 110 may refer to, based on an optical microscope or scanning electron microscope (SEM) photograph of a cross-section taken along the length direction (L-axis direction)—the thickness direction (T-axis direction) at a center of the body 110 in the width direction (W-axis direction), a maximum value among lengths of a plurality of line segments that connect two outermost boundary lines opposing each other in the length direction (L-axis direction) of the body 110 shown in the above-described cross-sectional photograph and are parallel to the length direction (L-axis direction). Alternatively, the length of the body 110 may refer to a minimum value among lengths of the plurality of line segments that connect two outermost boundary lines opposing each other in the length direction (L-axis direction) of the body 110 shown in the above-described cross-sectional photograph and are parallel to the length direction (L-axis direction). Alternatively, the length of the body 110 may refer to an arithmetic average value of lengths of at least two line segments among the plurality of line segments that connect two outermost boundary lines opposing each other in the length direction (L-axis direction) of the body 110 shown in the above-described cross-sectional photograph and are parallel to the length direction (L-axis direction).

A thickness of the body 110 may refer to, based on an optical microscope or scanning electron microscope (SEM) photograph of a cross-section taken along the length direction (L-axis direction)—the thickness direction (T-axis direction) at a center of the body 110 in the width direction (W-axis direction), a maximum value among lengths of the plurality of line segments that connect two outermost boundary lines opposing each other in the thickness direction (T-axis direction) of the body 110 shown in the above-described cross-sectional photograph and are parallel to the thickness direction (T-axis direction). Alternatively, the thickness of the body 110 may refer to a minimum value among lengths of the plurality of line segments that connect two outermost boundary lines opposing each other in the thickness direction (T-axis direction) of the body 110 shown in the above-described cross-sectional photograph and are parallel to the thickness direction (T-axis direction). Alternatively, the thickness of the body 110 may refer to an arithmetic average value of lengths of at least two line segments among the plurality of line segments that connect two outermost boundary lines opposing each other in the thickness direction (T-axis direction) of the body 110 shown in the above-described cross-sectional photograph and are parallel to the thickness direction (T-axis direction).

A width of the body 110 may refer to, based on an optical microscope or scanning electron microscope (microscope SEM) photograph of a cross-section taken along the length direction (L-axis direction)—the width direction (W-axis direction) at a center of the body 110 in the thickness direction (T-axis direction), a maximum value among lengths of the plurality of line segments that connect two outermost boundary lines opposing each other in the width direction (W-axis direction) of the body 110 shown in the above-described cross-sectional photograph and are parallel to the width direction (W-axis direction). Alternatively, the width of the body 110 may refer to a minimum value among lengths of the plurality of line segments that connect two outermost boundary lines opposing each other in the width direction (W-axis direction) of the body 110 shown in the above-described cross-sectional photograph and are parallel to the width direction (W-axis direction). Alternatively, the width of the body 110 may refer to an arithmetic average value of lengths of at least two line segments among the plurality of line segments that connect two outermost boundary lines opposing each other in the width direction (W-axis direction) of the body 110 shown in the above-described cross-sectional photograph and are parallel to the width direction (W-axis direction).

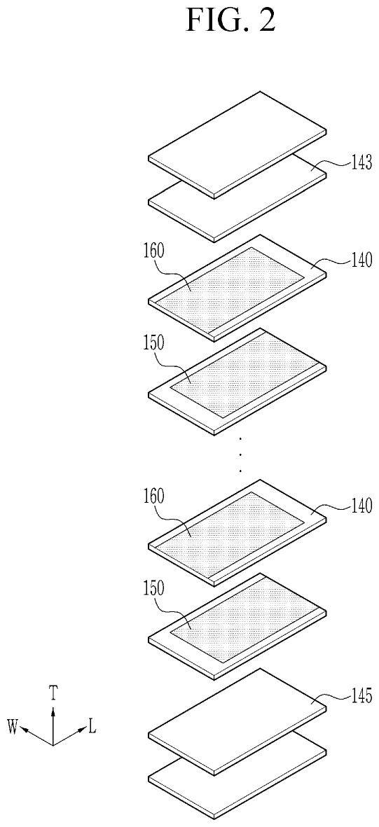

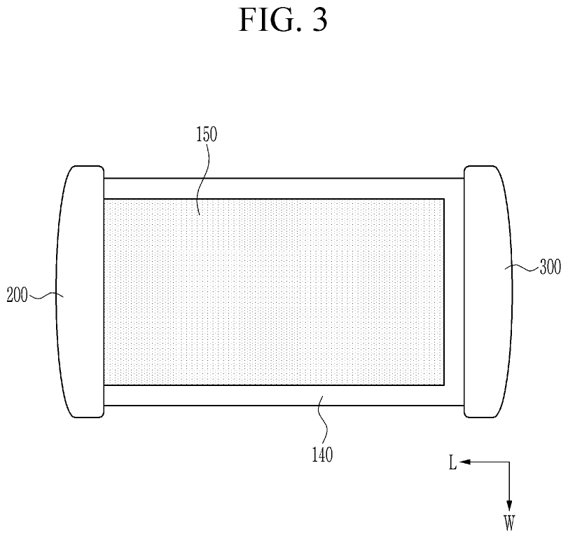

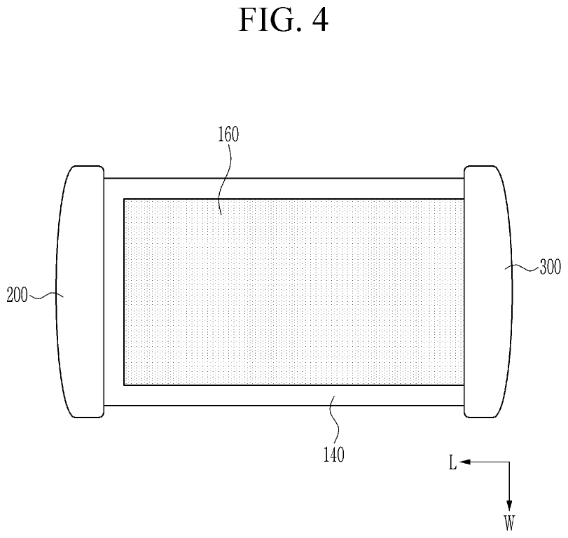

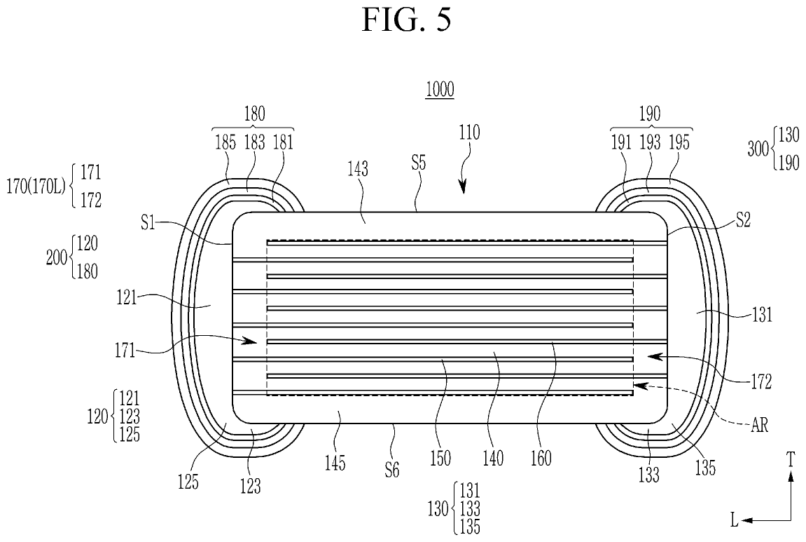

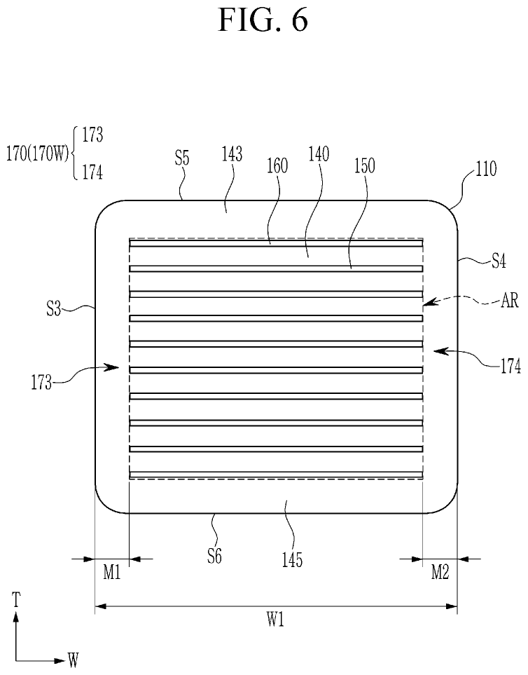

FIG. 2 is an exploded perspective view schematically showing a stacking structure of internal electrodes of the multilayer ceramic capacitor of FIG. 1, FIG. 3 is a top plan view schematically showing a first internal electrode of the multilayer ceramic capacitor of FIG. 1, and FIG. 4 is a top plan view schematically showing a second internal electrode of the multilayer ceramic capacitor of FIG. 1. FIG. 5 is a cross-sectional view taken along line I-I′ of FIG. 1, and FIG. 6 is a cross-sectional view taken along line II-II′ of FIG. 1.

Referring to FIG. 2, FIG. 3, FIG. 4, FIG. 5, and FIG. 6, the body 110 may include a plurality of dielectric layers 140, a first internal electrode 150, and a second internal electrode 160.

The plurality of dielectric layers 140 may be stacked in the thickness direction (T-axis direction) of the body 110. Boundaries between the dielectric layers 140 may be unclear. For example, it may be difficult to observe the boundaries between the dielectric layers 140 without using a scanning electron microscope (SEM), and the plurality of dielectric layers 140 may appear to be an integral structure.

The dielectric layer 140 may include a ceramic material. For example, the ceramic material may include dielectric ceramic including components such as at least one selected from the group consisting of BaTiO₃, CaTiO₃, SrTiO₃, and CaZrO₃. In addition, the dielectric layer may further include an auxiliary component, including such as at least one selected from the group consisting of a manganese (Mn) compound, an iron (Fe) compound, a chromium (Cr) compound, a cobalt (Co) compound, a nickel (Ni) and combinations thereof, or the like, in addition to the ceramic material. For example, the dielectric layer may include at least one selected from the group consisting of (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and combination thereof, or the like, in which calcium (Ca), zirconium (Zr), or the like is partially dissolved into BaTiO₃, but the present disclosure is not limited thereto.

Additionally, the dielectric layer 140 may further include one or more of ceramic additives, organic solvents, plasticizers, binders, and dispersants. Examples of the ceramic additive may include at least one selected from the group consisting of transition metal oxides or carbides, rare earth elements, magnesium (Mg), aluminum (Al), and combinations thereof, or the like.

The first internal electrode 150 and the second internal electrode 160 may be alternately stacked with the dielectric layer 140 interposed therebetween. This stack structure may be repeated inside the body 110, the internal electrode closest to the first surface S1 of the body 110 may be a first internal electrode 150 or a second internal electrode 160, and the internal electrode closest to the second surface S2 of the body 110 may be a first internal electrode 150 or a second internal electrode 160.

The first internal electrode 150 and the second internal electrode 160 have different polarities, and may be electrically insulated from each other by the dielectric layer 140 disposed therebetween.

The first internal electrode 150 and the second internal electrode 160 may be formed by printing a conductive paste that includes a metal on a surface of the dielectric layer 140. For example, a conductive paste including nickel (Ni) or nickel (Ni) alloy may be printed on the surface of the dielectric layer using screen printing or gravure printing to form the internal electrode. However, the embodiment is not limited thereto.

When a voltage is applied to the first external electrode 200 and the second external electrode 300, an electric charge accumulates between the first internal electrode 150 and the second internal electrode 160. That is, capacitance may be generated between the first internal electrode 150, which is electrically connected to the first external electrode 200, and the second internal electrode 160, which is electrically connected to the second external electrode 300. Capacitance of the multilayer ceramic capacitor 1000 may be proportional to an area where the first internal electrode 150 and the second internal electrode 160 overlap each other along the thickness direction (T-axis direction).

In other words, the multilayer ceramic capacitor 1000 may include an active region AR and a margin region 170.

The active region AR may be a region where the first internal electrode 150 and the second internal electrode 160 overlap along the thickness direction (T-axis direction).

The margin region 170 may be a region that includes the same material as the material forming the dielectric layer 140 in the remaining regions of the body 110, but may be a region where the internal electrodes 150 and 160 are not disposed. The margin region 170 may include a widthwise margin region 170W and a lengthwise margin region 170L.

The lengthwise margin region 170L may include a first margin region 171 and a second margin region 172. The first margin region 171 may be a region between the active region AR and the first surface S1 of the body 110, and the second margin region 172 may refer to a region between the active region and the second surface S2 of the body 110.

The widthwise margin region 170W may include a third margin region 173 and a fourth margin region 174. The third margin region 173 may be a region between the active region AR and the third surface S3 of the body 110, and the fourth margin region 174 may refer to a region between the active region AR and the fourth surface S4 of the body 110.

Referring to FIG. 6, the body 110 has a width W1, the third margin region 173 has a first margin width M1, and the fourth margin region 174 has a second margin width M2. That is, the width of the widthwise margin region 170W may be a sum (M1+M2) of the first margin width M1 and the second margin width M2.

A ratio (hereinafter, referred to as “margin ratio”) of the width (M1+M2) of the widthwise margin region 170W to the width W1 of the body 110 may be greater than 8.5% and less than or equal to 9.5%. In some embodiments, the margin ratio may be greater than 8.5%, 8.6%, 8.7%, 8.8%, 8.9%, 9%, 9.1%, 9.2%, 9.3% or 9.4% and/or less than or equal to 9.5%, 9.4%, 9.3%, 9.2%, 9.1%, 9%, 8.9%, 8.8%, 8.7% or 8.6%.

If the margin ratio is 8.5% or less, the widthwise margin region is relatively thin, and external moisture or hydrogen may easily penetrate, which may reduce the moisture resistance reliability of the multilayer ceramic capacitor.

If the margin ratio exceeds 9.5%, the active region AR becomes relatively small, which may cause the capacitance of the multilayer ceramic capacitor to degrade.

Here, the widths M1 and M2 of the widthwise margin region 170W may be measured based on an optical microscope or scanning electron microscope of a cross-section taken along the width direction (W-axis direction)—the thickness direction (T-axis direction) at a center of the multilayer ceramic capacitor 1000 in the length direction (L-axis direction). The first margin width M1 may be an arithmetic average value of a width of the third margin region 173 measured at an uppermost point, a width of the third margin region 173 measured at a lowermost point, and a width of the third margin region 173 measured at a center, respectively, in the thickness direction (T-axis direction) of the body 110, shown in the above-described cross-sectional photograph. In addition, the second margin width M2 may be an arithmetic average value of a width of the fourth margin region 174 measured at an uppermost point, a width of the fourth margin region 174 measured at a lowermost point, and a width of the fourth margin region 174 measured at a center, respectively, in the thickness direction (T-axis direction) of the body 110, shown in the above-described cross-sectional photograph.

Meanwhile, the widthwise margin region 170W may have an average porosity of greater than 0% and less than 1.1%. In some embodiments, the widthwise margin region 170W may have an average porosity of greater than 0%, 0.1%, 0.2%, 0.3%, 0.4%, 0.5%, 0.6%, 0.7%, 0.8%, 0.9%, or 1% and/or less than 1.1%, 1%, 0.9%, 0.8%, 0.7%, 0.6%, 0.5%, 0.4%, 0.3%, 0.2% or 0.1%.

If the average porosity of the widthwise margin region 170W is 1.1% or more, external moisture or hydrogen may easily penetrate through the margin region, which may reduce the moisture resistance reliability of the multilayer ceramic capacitor.

Here, the average porosity may be measured based on an optical microscope or scanning electron microscope of a cross-section taken along the width direction (W-axis direction)—the thickness direction (T-axis direction) at a center of the multilayer ceramic capacitor 1000 in the length direction (L-axis direction). For example, using an image analysis software known in the art, a region of 10 um×10 um is selected from an uppermost point, a lowermost point, and a center of the widthwise margin region in the thickness direction (T-axis direction) shown in the above-described cross-sectional photograph, porosities are obtained by measuring the areas of the selected regions and the areas of pores in the selected regions, and then these values are arithmetically averaged to obtain the average porosity.

For example, by controlling the amount of residual carbon during the calcination step of a dielectric green sheet laminate during the manufacturing process of the multilayer ceramic capacitor, the average porosity of the widthwise margin region may be controlled to a certain range.

Referring to FIG. 5 and FIG. 6, a first cover layer 143 and a second cover layer 145 may be disposed on upper and lower outer surfaces of the active region AR in the thickness direction (T-axis direction).

The first cover layer 143 may be disposed between the fifth surface S5 of the body 110 and the internal electrode closest to the fifth surface S5 of the body 110. The second cover layer 145 may be disposed between the sixth surface S6 of the body 110 and the internal electrode closest to the sixth surface S6 of the body 110.

That is, within the body 110, the first cover layer 143 may be disposed at an upper portion of an uppermost internal electrode, and the second cover layer 145 may be disposed at a lower portion of a lowermost internal electrode. In some embodiments, the first cover layer 143 and the second cover layer 145 may have the same composition as the dielectric layer 140. The first cover layer 143 and the second cover layer 145 may be formed by stacking one or more dielectric layers on an outer surface of the uppermost internal electrode and an outer surface of the lowermost internal electrode. In some embodiments, the first cover layer 143 and the second cover layer 145 may have different compositions from the dielectric layer 140.

The first cover layer 143 and the second cover layer 145 may serve to prevent damage to the first internal electrode 150 and the second internal electrode 160 by a physical or chemical stress.

The first external electrode 200 and the second external electrode 300 may be disposed on outer surfaces the body 110.

The first external electrode 200 may be disposed on the first surface S1 of the body 110 and may extend onto the third surface S3, the fourth surface S4, the fifth surface S5 and the sixth surface S6 of the body. The second external electrode 300 may be disposed on the second surface S2 of the body 110 and may extend onto the third surface S3, the fourth surface S4, the fifth surface S5 and the sixth surface S6. In another embodiment, the first external electrode 200 and the second external electrode 300 may extend onto a portion of at least one of the fifth surface S5 and the sixth surface S6 of the body.

The first external electrode 200 may include a first electrode layer 120 and a first plating layer 180.

The first electrode layer 120 may include a first connection portion 121, a first band portion 123 and a first corner portion 125.

The first connection portion 121 may cover the first surface S1 of the body 110, and be electrically connected to a plurality of first internal electrodes 150.

In another embodiment, the first connection portion 121 may cover a portion of the first surface S1 of the body 110.

The first band portion 123 may extend from the first connection portion 121 to cover at least a portion of the third surface S3, the fourth surface S4 and the fifth surface S5, and/or to cover at least a portion of the third surface S3 of the body 110, the fourth surface S4 and the sixth surface S6 of the body 110. The first band portion 123 may ensure the first electrode layer 120 is more strongly adhered to the body 110.

The first corner portion 125 may be a portion that connects the first connection portion 121 and the first band portion 123.

The second external electrode 300 may include a second electrode layer 130 and a second plating layer 190.

The second electrode layer 130 may include a second connection portion 131, a second band portion 133, and a second corner portion 135, respectively.

The second connection portion 131 may cover the second surface S2 of the body 110, and be electrically connected to a plurality of second internal electrodes 160.

In another embodiment, the second connection portion 131 may cover a portion of the second surface S2 of the body 110.

The second band portion 133 may extend from the second connection portion 131 to cover at least a portion of the third surface S3, the fourth surface S4 and the fifth surface S5 of the body, and/or to cover at least a portion of the third surface S3, the fourth surface S4 and the sixth surface S6 of the body 110. The second band portion 133 may ensure the second electrode layer 130 is more strongly adhered to the body 110.

The second corner portion 135 may be a portion that connects the second connection portion 131 and the second band portion 133.

Based on an optical microscope or scanning electron microscope (SEM) photograph of a cross-section taken along the length direction (L-axis direction)—the thickness direction (T-axis direction) at a center of the multilayer ceramic capacitor 1000 in the width direction (W-axis direction), in the multilayer ceramic capacitor 1000 shown in the above-described cross-sectional photograph, the first connection portion 121 and the second connection portion 131 may have a shape substantially parallel to the thickness direction (T-axis direction), the first band portion 123 and the second band portion 133 may have a shape substantially parallel to the length direction (L-axis direction), and the first corner portion 125 and the second corner portion 135 may have a curved line shape. The above-described curved line shape may be a curved line shape having a tangent whose slope changes from a direction parallel to the thickness direction (T-axis direction) to a direction parallel to the length direction (L-axis direction) (or in opposite directions).

The first electrode layer 120 and the second electrode layer 130 may be formed of a conductive material including, for example, at least one selected from the group consisting of copper (Cu), aluminum (Al), silver (Ag), tin (Sn), gold (Au), nickel (Ni), lead (Pb), chromium (Cr), titanium (Ti), and an alloy thereof, but is not limited thereto.

As another example, the first electrode layer 120 and the second electrode layer 130 may include a metal and glass. For example, the metal may be a conductive metal including at least one selected from the group consisting of copper (Cu), nickel (Ni), tin (Sn), palladium (Pd), platinum (Pt), gold (Au), silver (Ag), tungsten (W), titanium (Ti), lead (Pb), and an alloy thereof. The glass component included in the electrode layer may be a mixture of oxides. The glass component may include, for example, at least one selected from the group consisting of a silicon oxide, a boron oxide, an aluminum oxide, a transition metal oxide, an alkali metal oxide, an alkaline-earth metal oxide, and a combination thereof. Here, the transition metal may be selected from the group consisting of zinc (Zn), titanium (Ti), copper (Cu), vanadium (V), manganese (Mn), iron (Fe), and nickel (Ni), the alkali metal may be selected from the group consisting of lithium (Li), sodium (Na), and potassium (K), and the alkaline-earth metal may be selected from the group consisting of magnesium (Mg), calcium (Ca), strontium (Sr), and barium (Ba). The method of forming the electrode layer may not be particularly limited. For example, the electrode layer may be formed by dipping a body into a conductive paste containing metal and glass, or by printing a conductive paste on a surface of the body by, e.g., screen printing or gravure printing method, or the like. Alternatively, various methods such as applying a conductive paste on the surface of the body or transferring a dry film formed by drying a conductive paste to a body, may be used.

The first plating layer 180 may cover the first electrode layer 120, and the second plating layer 190 may cover the second electrode layer 130.

Both the first plating layer 180 and the second plating layer 190 may comprise a plurality of layers. For example, the first plating layer 180 may include a first layer 181 covering the first electrode layer 120, a second layer 183 covering the first layer 181, and a third layer 185 covering the second layer 183. The first layer may include nickel (Ni), and the second layer may include copper (Cu), and the third layer may include tin (Sn), but the present embodiment is not limited thereto.

In addition, the second plating layer 190 may include a first layer 191 covering the second electrode layer 130, a second layer 193 covering the first layer 191, and a third layer 195 covering the second layer 193. The first layer 191 may include nickel (Ni), and the second layer 193 may include copper (Cu), and the third layer 195 may include tin (Sn), but the present embodiment is not limited thereto.

### Preparation Example: Manufacture of Multilayer Ceramic Capacitor

### Example 1

A paste including barium titanate (BaTiO₃) powder was applied on a carrier film and dried to manufacture a plurality of dielectric green sheets.

A conductive paste including nickel (Ni) was applied on the dielectric green sheet using screen printing to form a conductive paste layer.

A plurality of dielectric green sheets was stacked such that at least portions of the conductive paste layers overlap each other, to manufacture a dielectric green sheet stack.

After cutting the dielectric green sheet stack into individual chips, a first calcination (or debinding) was performed by maintaining the individual chips at 400° C. for 70 hours in a nitrogen atmosphere, and a second calcination was performed by maintaining the individual chips at 900° C. for 6 hours in a hydrogen atmosphere.

The dielectric green sheet stack was fired at 1165° C. in a reducing atmosphere to manufacture a body.

A paste including a glass frit and copper (Cu) was applied to an outer surface of the body by dipping, dried, and then fired to form an external electrode.

Nickel (Ni) and tin (Sn) plating was performed on the external electrode, and heat treatment was performed at 160° C. for 1 hour to manufacture a multilayer ceramic capacitor.

The margin ratio of the manufactured multilayer ceramic capacitor was 8.8%, and the average porosity of the widthwise margin region was 0.84%.

### Example 2

The results were the same as Example 1 except that the margin ratio was 9.5% and the average porosity of the widthwise margin region was 0.84%.

### Comparative Example 1

The results were the same as Example 1 except that the margin ratio was 8.3% and the average porosity of the widthwise margin region was 1.35%.

### Comparative Example 2

The results were the same as Example 1 except that the margin ratio was 8.5% and the average porosity of the widthwise margin region was 1.1%.

### Comparative Example 3

The results were the same as Example 1 except that the margin ratio was 9.6% and the average porosity of the widthwise margin region was 1.1%.

### Experimental Example: Moisture Resistance Reliability of Multilayer Ceramic Capacitor

After manufacturing one hundred (100) pieces of multilayer ceramic capacitors according to Example 1 and Example 2 and Comparative Examples 1 to 3, the moisture resistance reliability was measured.

Solder cream was patterned using a stencil mask on a 40-channel moisture-resistant PCB board. Thereafter, a reflow process was performed at a maximum temperature of 260° C., and the prepared specimen was mounted on the PCB board. The prepared PCB board was mounted in a slot capable of measuring potential difference and current, and was put into a chamber with a temperature of 85° C. and a humidity of 85% RH (Relative Humidity). Thereafter, in a first step of 1 hour and a second step of 1 hour in which a potential difference of 7.56 V was applied to both ends of the specimen and a third step of 2 hours in which a potential difference of 4.5 V was applied to both ends of the specimen, the level of deterioration in insulation resistance (IR) was checked to measure moisture resistance reliability. Multilayer ceramic capacitors whose insulation resistance could not be measured were deemed “defective,” and those with insulation resistance of 10⁶Ω or less were deemed “degraded.”

The number of samples with defective moisture resistance reliability and degraded insulation resistance out of 100 samples each was counted.

The results are summarized in Table 1.

TABLE 1

| | | | Defective | |
|---|---|---|---|---|
| | | | moisture | Degraded |
| | Margin ratio | Average | resistance | insulation |
| | (%) | porosity (%) | reliability | resistance |
| Example 1 | 8.8 | 0.84 | 0/100 | 0/100 |
| Comparative | 8.3 | 1.35 | 25/100 | 25/100 |
| Example 1 | | | | |
| Comparative | 8.5 | 1.10 | 0/100 | 25/100 |
| Example 2 | | | | |
| Example 2 | 9.5 | 0.84 | 0/100 | 0/100 |
| Comparative | 9.6 | 1.10 | 25/100 | 25/100 |
| Example 3 | | | | |

Referring to Table 1, the multilayer ceramic capacitors according to Example 1 and Example 2 did not show defective moisture resistance reliability and degraded insulation resistance, whereas the multilayer ceramic capacitor according to Comparative Examples 1 to 3 showed defective moisture resistance reliability and/or degraded insulation resistance. This appears to be because, in the case of Comparative Examples 1 to 3, the margin ratio was relatively small or the average porosity was relatively high, which allowed external moisture or hydrogen to penetrate.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000: multilayer ceramic capacitor
110: body
120: first electrode layer
130: second electrode layer
200: first external electrode
300: second external electrode
140: dielectric layer
143: first cover layer
145: second cover layer
150: first internal electrode
160: second internal electrode
170: margin region
180: first plating layer
190: second plating layer

What is claimed is:

1. A multilayer ceramic capacitor, comprising:
a body comprising a first surface and a second surface opposing each other in a first direction, a third surface and a fourth surface opposing each other in a second direction intersecting the first direction, a fifth surface and a sixth surface opposing each other in a third direction intersecting both of the first direction and the second direction, and comprising a plurality of dielectric layers and a plurality of internal electrodes stacked in the third direction; and
an external electrode disposed on an outer surface the body,
wherein the body comprises a margin region where no internal electrode is disposed, the margin region being a region including between an outer circumference of the plurality of internal electrodes and the third surface and a region including between an outer circumference of the plurality of internal electrodes and the fourth surface,
wherein a ratio of a width of the margin region to a width of the body, measured along the second direction, is greater than 8.5% and less than or equal to 9.5%, and
wherein an average porosity of the margin region is greater than 0% and less than 1.1%.

2. The multilayer ceramic capacitor of claim 1, wherein the margin region comprises the same dielectric layer as the dielectric layer in the remaining regions of the body.

3. The multilayer ceramic capacitor of claim 1, wherein the plurality of internal electrodes comprises a plurality of first internal electrodes and a plurality of second internal electrodes disposed staggered from each other in the first direction.

4. The multilayer ceramic capacitor of claim 3, wherein the external electrode comprises:
a first external electrode disposed on the first surface and connected to the plurality of first internal electrodes; and
a second external electrode disposed on the second surface and connected to the plurality of second internal electrodes.

5. The multilayer ceramic capacitor of claim 1, further comprising:
a plating layer covering the external electrode.

6. The multilayer ceramic capacitor of claim 5, wherein the plating layer comprises:
a first layer covering the external electrode;
a second layer covering the first layer; and
a third layer covering the second layer.

7. The multilayer ceramic capacitor of claim 6, wherein
the first layer comprises nickel (Ni).

8. The multilayer ceramic capacitor of claim 6, wherein the second layer comprises copper (Cu).

9. The multilayer ceramic capacitor of claim 6, wherein the third layer comprises tin (Sn).

10. The multilayer ceramic capacitor of claim 6, wherein:
the first layer comprises nickel (Ni),
the second layer comprises copper (Cu); and
the third layer comprises tin (Sn).
